(19) United States
(12) Patent Application Publication
(10) Pub. No.: US 2013/0244136 A1
(43) Pub. Date: Sep. 19, 2013

(54) DEVICE FORMING A SEAL BETWEEN TWO SPACES HAVING MUTUALLY REACTIVE GASES, AND USE IN HIGH TEMPERATURE STEAM ELECTROLYSIS (HTSE) UNITS AND IN SOLID OXIDE FUEL CELLS (SOFC)

(71) Applicants: Gatien Fleury, Greoux Les Bains (FR); Patrick Le Gallo, Saint Appolinard (FR)

(72) Inventors: Gatien Fleury, Greoux Les Bains (FR); Patrick Le Gallo, Saint Appolinard (FR)

(73) Assignee: Commissariat a l'energie atomique et aux ene alt, Paris (FR)

(21) Appl. No.: 13/989,301

(22) PCT Filed: Nov. 23, 2011
(86) PCT No.: PCT/EP11/70828

§ 371 Date: May 23, 2013

(30) Foreign Application Priority Data
Nov. 23, 2010 (FR) 10 59639

(51) Int. Cl. H01M 8/02; C25B 9/18

(52) U.S. Cl. CPC H01M 8/0276; H01M 8/0282; C25B 9/18
USPC 429/516; 204/267

(57) ABSTRACT

A seal between two spaces able to be occupied by two mutually reactive gases, typically oxygen and hydrogen. A buffer chamber is produced between the two spaces of mutually reactive gases, wherein leaks of reactive gases to the buffer chamber are determined to produce a flow which is mainly of diffusive type, for example by molecular or Knudsen diffusion. Such a seal may, for example, find application to production of a seal in an EHT electrolyser or a fuel cell of SOFC type.

### TECHNICAL FIELD

The present invention relates to a device forming a seal between two spaces each of which can be occupied by a gas, where the gases are mutually reactive, forming a fluid.

In the context of the invention the expression “mutually reactive gases” means two gases which, when both are present, react to form a fluid in the form of a gas or vapour. Typically hydrogen thus reacts with oxygen to form water in the form of steam.

The invention has an application in particular in high-temperature steam electrolysis (EVHT), typically at between 600° C. and 1000° C., where there is currently no seal which is able to satisfy at once the constraints of the medium (high-temperature, oxidation-reduction atmosphere, etc.), and of the system (thermal transients).

The invention may also be applied to other fields, such as fuel cells of the SOFC type, or for reactors in the chemical industry, and for systems operating in other temperature ranges, where it is difficult to produce a seal.

### PRIOR ART

In the field of high-temperature electrolysis of water or fuel cells there is presently a requirement to separate a gas containing, among others, oxygen, from a gas containing, among others, hydrogen. Indeed, when both are present these gases react spontaneously. Firstly this reaction impairs the reactor's overall efficiency, and secondly it dissipates heat locally and can therefore damage the system. Until the present time designers of EHT electrolysis reactors or of fuel cells have therefore sought to insert seals the function of which was to separate these gases from one another, simply by creating a sealed barrier.

In the temperature ranges in question there is currently no simple and satisfactory solution to resolve this problem. For each type of reaction and reactor architecture standard solutions must therefore be modified, or new developments must be produced.

In high-temperature electrolysers or fuel cells the seals are conventionally made by glass seals or glass/glass-ceramic composite, since they have, essentially, three advantages: satisfactory electronic insulation, excellent sealing, and they require no mechanical clamping. The major disadvantages of these glass or glass-ceramic composite seals are, conversely:
the are very fragile below their glass transition temperature or their crystallisation temperature, and they can fracture if they are subject to stress, notably due to differential thermal expansions; during violent thermal cycles the seal may then be breached;
the need for a temperature excursion above the operating temperature to produce the seal; this excursion may be harmful for the metal interconnecting materials, and those constituting the reactive cell, which may imply that the reactor's efficiency is impaired;
potential chemical incompatibility with the other components of the cell and of the interconnector(s), for example emission of SiO₂ vapours, which are polluting for the electrodes, or substantial corrosion of the gasket surfaces;
creation of a rigid connection between the components of the stack; stresses may then result during thermal transients;
difficulty of disassembling components, or even impossibility of so doing without changing the cell or stack of cells.

Solutions consist in brazing the metal of the interconnector on the ceramic. However, achieving wetting of the metal of the interconnector on the ceramic, together with the thermal expansion differences between these two materials, make this operation very difficult for large dimensions. Indeed, cooling after solidification of the soldering seam regularly causes breakage of the ceramic.

Lastly, other mica-based, or simply metal, compressive seals have been proposed: installing them requires a substantial volume and very substantial external clamping, which is difficult to control and to maintain at temperature in order to obtain effective sealing without the cell fracturing during heating. At operating temperatures, indeed, the very powerful clamping implies creep, and therefore variations of the electrolysers' components, and therefore at best a loss of sealing.

To compensate for the defects of each of these conventional solutions it has previously been proposed to combine several of these solutions with, for example, composite seals made of mica and glass.

The aim of the invention is to propose another sealing solution between two spaces occupied by mutually reactive gases.

One particular aim of the invention is to propose another sealing solution capable of completing and protecting a sealing solution which exists in a high-temperature water electrolysis reactor (EHT) or in a reactor constituting a fuel cell, notably of the SOFC type.

### DESCRIPTION OF THE INVENTION

To accomplish this one object of the invention is a device forming a seal to separate two spaces each of which may be occupied by a gas, where the gases react with one another to form a fluid, where the device includes at least one plate and one chamber, called a buffer chamber, separating the two spaces, and where the buffer chamber may be occupied by the same fluid as the one formed by reaction of the two reactive gases with one another.

According to the invention:
one of the two spaces is separated from the chamber by a first supporting portion and a plate portion facing it;
the other of the two spaces is separated from the chamber by a second supporting portion and a plate portion facing it;
each of the first and second supporting portions forms with the plate portion facing it a supporting area defining a microchannel; where the microchannels are porous volumes delimited by the surface roughnesses of the supporting portions and of the plate portions;

the flow of the reactive gases in the microchannels is principally of the molecular type.

It is stipulated that in the context of the invention the term “microchannel” means a fluid channel the height of which is micrometric in size, defined by the surface roughnesses of the support and plate portions, i.e. typically a channel the height, or in other words the depth, of which is of the order of some ten μm (micrometres). Also typically, the width of a microchannel defined by the surface roughnesses of the supporting and plate portions is the order of some fifty to some one hundred μm (micrometres).

In other words, the inventors have defined a new type of seal: unlike seals according to the state of the art, for which it is sought to give them a perfect barrier function, in this case an imperfect sealing area is defined controlled by the molecular flow and a buffer chamber in which the two reactive gases present may combine with one another. Moreover, in certain configurations one of the two surfaces is very rough or porous, making this type of barrier solution according to the state of the art particularly unrealistic.

In other words, also, the device forming a seal according to the invention is a pneumatic seal which consists in slowing the movement of at least one of the two reactive gases, i.e. the one having the smaller molar mass, by a steric effect. A barrier of a larger quantity of molecules of higher molar mass is interposed before the molecule of the reactive gas in question. The fluid resulting from the reaction between the two reactive gases which is present inside the buffer chamber has an effective collision cross-section which is much higher than that of each of the two reactive gases. By this means, using the device according to the invention, the molecular diffusion of the reactive gases within the microchannels is necessarily reduced. In the preferred application in which it is sought to seal a space of hydrogen H₂ relative to a space of oxygen O₂, a buffer chamber occupied by steam of much higher effective cross-section implies a lesser molecular diffusion of H₂ and of O₂ in the microchannels. In addition, the buffer chamber according to the invention enables the exchanges of reactive gases between the two spaces to be stabilised, i.e. the gradient between these two spaces to be reduced to the greatest extent.

Finally, the buffer fluid in the chamber reduces the reaction rate between the two reactive gases. In the abovementioned preferred application the steam in the chamber reduces the reaction rate between H₂ and O₂ each deriving from one of the spaces either side of the chamber. In the preferred application the effective collision cross-section is evaluated respectively at:
0.282 nm for H₂;
0.317 nm for steam;
0.346 for O₂.

In order to dimension each buffer chamber those skilled in the art will seek to find a compromise between the different functions of the seal to be produced, notably related to the design constraints and constraints on use of the pneumatic system of the reactive gases, i.e. the conditions of occupation of the spaces according to the invention.

These constraints are as follows:
the compression force used to produce the seal,
the height and width of the buffer chamber,
the operating temperature of the electrochemical reactor in which the sealing device is incorporated,
the pressures of the reactive gases.

The dimensions (height and width) of the buffer chamber are preferably chosen in accordance with the seal's usage constraints. The lower the pressure and the higher the temperature, the greater must be the volume of the buffer chamber to allow the transformation of the mutually reactive gases.

The volume of gas must also enable the heat released in the reaction to be absorbed.

Those skilled in the art ensure that the compression force allows both the molecular flow conditions (of the Knudsen type) between the supporting portions and corresponding plate portions in the supporting areas to be implemented principally, and also ensure that excessive creep of the structure (plate and supporting portions) may not develop.

The structure of the seal is preferably produced in the supporting portions with the same technology and using the same methods as the remainder of the parts used, such as the plates.

According to one advantageous embodiment, the walls of the chamber and the supporting portions are formed from a single separation element sandwiched between the two said spaces.

The separation element typically consists of a pressed plate. The advantages of a separation element manufactured by pressing are that it can be manufactured in large series and inexpensively. With a separation element manufactured by this method, care is taken to choose a sufficiently fine plate thickness to allow easy pressing, but one which is sufficiently great for the alloy's reserve of minor elements (typically Al or Cr) to be sufficient to allow protection against oxidisation for the entire period of its use. Those skilled in the art select the most appropriate materials in accordance with the application (reactive gases, temperature, etc.), and with the way in which the seal has been incorporated: installed in a configuration where there is constant movement, respectively constant force, those skilled in the art take care, indeed, to limit, if applicable, the relaxation, or respectively the creep, of the separation element so as to be able to maintain a sufficient clamping force over time, and by this means to re-establish the seal after a thermal cycle of the said element.

The pressed plate may advantageously be made of a nickel alloy, such as Inconel 600, Inconel 718 or Haynes 230. It may also be made from a stainless steel, such as AISI 3105, AISI 316L or AISI 430.

The invention also relates to an electrochemical reactor including at least one device forming a seal as described above, in which the spaces either side separated by the seal are the spaces in which reactive gases flow within the reactor.

According to one embodiment in which the reactor includes a stack of elementary electrolysis cells, each formed of a cathode, an anode and an electrolyte sandwiched between the cathode and the anode, where at least one interconnecting plate is fitted between two adjacent elementary cells, in electrical contact with an electrode of one of the two elementary cells and an electrode of the other of the two elementary cells, where the interconnecting plate delimits at least one cathodic compartment and at least one anodic compartment for gas to flow respectively in the cathode and in the anode, it is provided that the cathodic compartment or the anodic compartment advantageously constitutes one of the two spaces separated by the device forming the seal,

This may advantageously be a high-temperature water electrolysis reactor, intended to operate at temperatures of over 450° C., typically between 600° C. and 1000° C.

It may also advantageously be a reactor constituting a fuel cell of the SOFC type, intended to operate at temperatures of between 600° C. and 800° C.

Typically a fuel cell of the SOFC type intended to operate with gases at pressures close to that of atmospheric pressure. In such a cell the buffer chamber preferably has the following dimensions:
height between 100 and 500 μm, where the height is defined as the distance between the base of the chamber and the support surface;
width at least equal to 500 μm, where the width is defined as the minimum distance between the two supporting portions of the separation element.

Also preferably, the bearing force between the supporting portions and the plate portions is between 0.1 N/mm and 10 N/mm.

The buffer chamber preferably has an annular shape around the space where the generated hydrogen is recovered.

Typically, in the case of a fuel cell of the SOFC type, operating at around atmospheric pressure and at 700° C.:
a plate 0.2 mm thick of Inconel 600 as a separation element enables the problems of corrosion and of mechanical properties over time to be addressed,
a buffer chamber height of between 100 to 500 μm and a width of at least 500 μm are suitable.

### BRIEF DESCRIPTION OF THE DRAWINGS

Other advantages and characteristics of the invention will be shown more clearly on reading the detailed description, given as an illustration and not restrictively, with reference to the following figures which:

FIG. 1 is a schematic view showing the operation of a device forming a seal according to the invention,

FIG. 2 is a perspective view of an element of a device according to a first embodiment of the invention;

FIG. 3 is a semi-perspective view of a device according to a second embodiment according to the invention,

FIG. 4 is a partial section view of FIG. 3,

FIG. 5 is a schematic view showing a device forming a seal according to the invention, according to another embodiment,

FIG. 6 is a schematic view showing a device forming a seal according to the invention, according to another embodiment,

FIGS. 7A to 7C represent the curves of the mean free paths respectively of air, hydrogen H₂, and steam H₂O according to pressure and temperature, where the mean free path enables a desired principally molecular flow to be defined with a seal according to the invention,

FIG. 8 is a schematic representation of different types of flow according to the Knudsen number, enabling a principally molecular flow to be defined from the mean free path.

### DETAILED DESCRIPTION OF PARTICULAR EMBODIMENTS

The device forming the seal is described below with reference to electrolysis of water (EHT) or to a fuel cell of the SOFC type.

The device forming the seal according to the invention includes a first space 1 occupied by hydrogen H₂ and a second space 2 occupied by oxygen O₂.

It includes a separation element 4 including two supporting portions 40, 41 which are held supported against a single support plate 5 with a given compression force which enables a flow, principally of the molecular type, of the molecules of reactive gases in defined microchannels 60, 61 (see arrows) to be obtained. Microchannels 60, 61 are porous volumes delimited by the surface roughnesses of supporting portions 40, 41 and of the portions of plate 5.

A buffer chamber 7 is delimited by supporting portions 40, 41 in which, in order for this characteristic to persist, the pressure difference between the oxygen and hydrogen chambers must not be too high (a few bars) in order that buffer chamber 7 remains the location where the gases react. The dimensions (height H and width L as shown in FIG. 4) of buffer chamber 7 are determined so as to allow the two reactive gases O₂, H₂ to react with one another inside it.

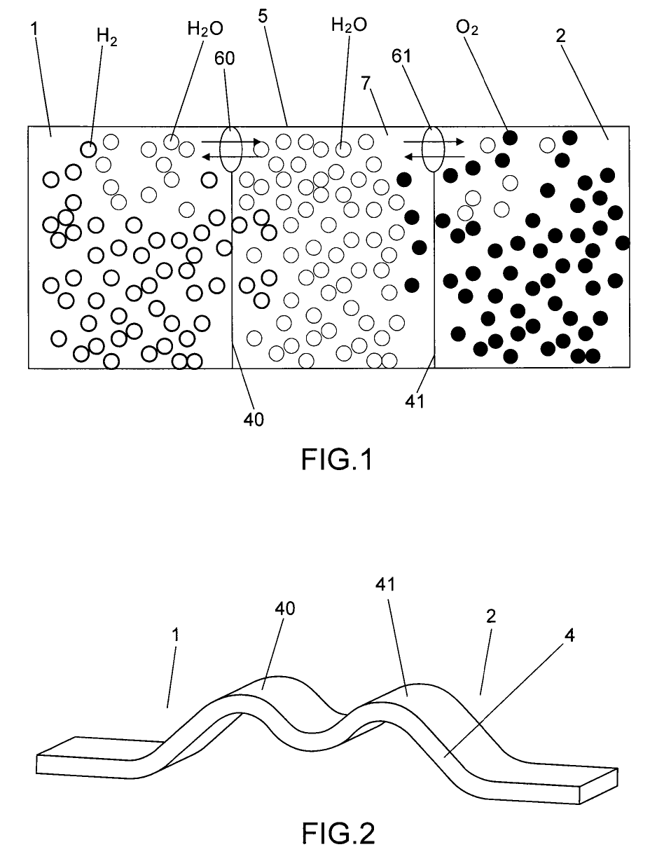

The physical phenomenon obtained with the device according to the invention is a reaction of recombination—one which is controlled in geometrical terms—of the two constituents, i.e. typically of the production of steam through the recombination of hydrogen and oxygen molecules (see FIG. 1). When this steam has been obtained it has advantageous characteristics such as:
its capacity to absorb the heat released from the recombination (the molar heat capacity of the water molecule is higher than for H₂ and O₂);
a viscosity and a molar mass which are higher than those of hydrogen, which will slow the leakage, whatever the mechanism of it (convective or diffusive);
creation of higher pressure than in the two spaces located either side which will also help slow the leakage.

Such a phenomenon is, indeed, obtained, since initially oxygen is located on one side (in space 2), and hydrogen on the other (in space 1). Buffer chamber 7 (in the centre) will gradually be filled with steam, if it is not so filled initially. It is supposed in this case that the reactive gases O₂, H₂ and steam H₂O are at equal pressure.

By the phenomenon of diffusion, four flows of the molecular type (Knudsen) will be established with different kinetics.

Between space 2 and buffer chamber 7 there are the following flows:
O₂→H₂O
H₂O→O₂.

Between space 1 and buffer chamber 7 there are the following flows:
H₂→H₂O
H₂O→H₂

Each of microchannels 60, 61 or, in other words, leakage zones, defined between a supporting portion 40, 41 and support plate 5 allows two gases to pass through which do not react, but which counteract one another in terms of flow.

Bearing in mind the ease with which the hydrogen flows it will therefore accumulate in buffer chamber 7. This increase will have two consequences:
it will reduce the concentration gradient between chamber 7 and space 1, and therefore limit its flow;
it will contribute to increasing the pressure in chamber 7.

Both these phenomena tend to slow the diffusion of hydrogen.

As the oxygen also arrives in buffer chamber 7 it reacts with the diluted hydrogen to form steam. This steam contributes to maintaining its concentration at equilibrium, and also to increasing pressure.

Globally, buffer chamber 7 is at high pressure relative to the two spaces 1, 2 which are to be isolated.

The formation of such a separation by a non-reactive fluid (steam) is particularly useful if the gases are regularly renewed either side of buffer chamber 7, which is the case in EHT electrolysers or fuel cells of the SOFC type.

This method enables a supply of a buffer gas, and therefore additional complexity, to be avoided.

Buffer chamber 7 may easily be produced from pressed shapes (FIG. 2).

These pressed shapes may be directly incorporated in a habitual component of an electrochemical reactor (an interconnecting plate).

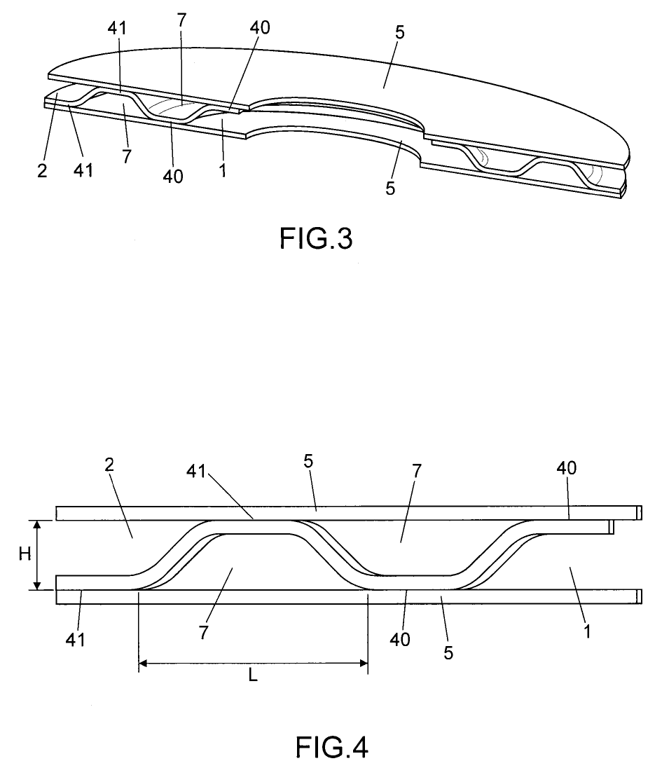

In FIGS. 3 and 4 a device forming a seal according to the invention has been illustrated, which constitutes what is habitually designated a seal of the “stand alone” type.

In these FIGS. 3 and 4 two buffer chambers 7 are installed in order to seal both sides of the pressed plate.

The device forming the seal according to the invention constitutes to some extent a dynamic seal which consists in controlling the leakages by molecular flow (of the Knudsen type). It is thus perfectly suitable for electrochemical applications with high operating temperatures, since it enables two parts in contact (separation element and support plate) to be allowed to slide, permitting substantial differential expansions.

The device forming a seal according to the invention which has just been described has many advantages.

In addition to the possible improvement of the quality of the seal compared to solutions according to the state of the art, production of the buffer chamber has only very little impact on cost in an EHT electrolyser, or a fuel cell of the SOFC type, since it consists of a slight modification of the shape of the pressed element.

Furthermore it may be added to a pre-existing seal.

In addition, it enables the heat release area to be better located in a stack of electrochemical cells of a reactor, and therefore its incorporation in the design of the latter.

Although described with reference to high-temperature electrolysis applications or fuel cells, the invention may be applied in other electrochemical reactors where it is sought to find a highly effective seal.

As previously mentioned, when incorporated directly in a reactor the device according to the invention requires only a single buffer chamber.

This being so, depending on the space and the compression force available to incorporate the separation element in an electrochemical reactor, it is perfectly possible to conceive putting several buffer chambers in series.

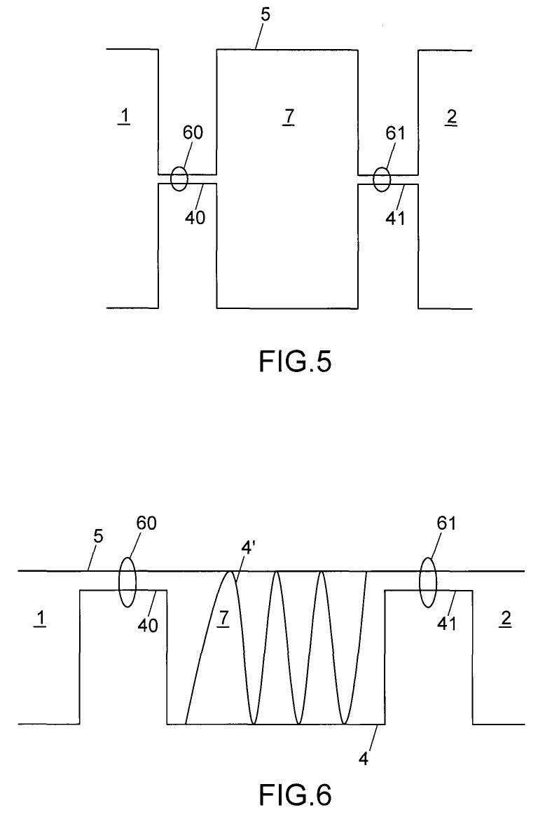

Support plate 5 on which separation element 4 rests shown in FIGS. 2 to 4 is flat: it is self-evident that it may take any shape which is supported with two supporting portions 40, 41 of the separation element. An example of another shape is shown in FIG. 5.

Finally, a single separation element 4 is shown in FIGS. 2 to 4: according to the invention, it is naturally possible to incorporate another separation element 4′ in a given buffer chamber 7 as represented in FIG. 6. This other separation element 4′ may, for example, be an additional part made of pressed plate.

In the preferred application which has just been described, the initial roughness of the surfaces of the materials constituting the seal (separation element 4 with its supporting portions 40, 41) and the span (support plate 5) opposite it will typically have an arithmetical mean deviation of Ra<0.4 μm, obtained by polishing, or by the care taken with the surfaces during production.

It is self-evident that the less rough the surface conditions of the supporting portions and plate portions, the better the seal obtained by virtue of the joint according to the invention, and the more the flow characteristics in microchannels 60, 61 are molecular, of the Knudsen type, rather than of the Darcy type.

In the case of a seal to be made between a metal span (metal support plate) and a metal seal (metal separation element 4), a linear force of 0.5 N for each mm of seal enables molecular flow characteristics of the Knudsen type to be obtained, provided the seal material used (metal separation element 4) is sufficiently soft at the operating temperature, for example a ferritic steel of the AISI 430 type at 600° C., and provided it is of low initial roughness (Ra<0.4 μm), and that the pressures in spaces 1, 2 and 7 are close to atmospheric pressure. Under these circumstances, the greater the linear pressure the more molecular flow characteristics tend to be obtained.

We now describe two different methods envisaged by the inventors to determine the flow characteristics through microchannels 60, 61 according to the invention defined by the states of roughness of the supporting portions and of the support plate.

The first method consists in comparing the value of the mean free path of the reactive gases, in this case respectively H2 and O2, and of the fluid formed by the reaction, in this case steam, with the dimensions of the microchannels defined by the states of roughness of the supporting portions and of the support plate.

To determine flow characteristics in a leakage area it is known to compare the value of the mean free path of the species concerned with the size of the defect which will be the cause of the leakage: see publication [1]. In the case of a metal seal, two types of leakage may occur: by permeation (through the seal) and by the microporosities located at the seal/span interface. In the case of the metal seals (separation elements) envisaged in connection with the invention, with smooth surface conditions, leakage by permeation is lower by an order of magnitude than the leakages at the interfaces. This leakage by permeation is therefore disregarded. Measurement of the microporosities located at the interface therefore enables the order of magnitude of the microchannels which are the cause of the leakage to be known. It is self-evident that a uniform and smooth surface condition is envisaged in all support and plate portions, i.e. with no microporosities substantially larger than the interface.

The mean free path λ of a fluid may be expressed by the following equation:

$$λ = \frac{3}{2} \cdot \frac{η}{P} \sqrt{\frac{π RT}{2 M}} \qquad ( 1 )$$

equation (1) in which:
λ designates the mean free path, in m;
η designates the dynamic viscosity, in Pa·s;
R designates the universal constant of perfect gases (8.314) in J·mol⁻¹·K⁻¹;
T designates the temperature in degrees Kelvin;
P the pressure in Pa;
M designates the molar mass of the fluid in g/mol.

The mean free path of the fluid therefore increases according to the temperature and dynamic viscosity of the fluid, but decreases according to the pressure and molar mass.

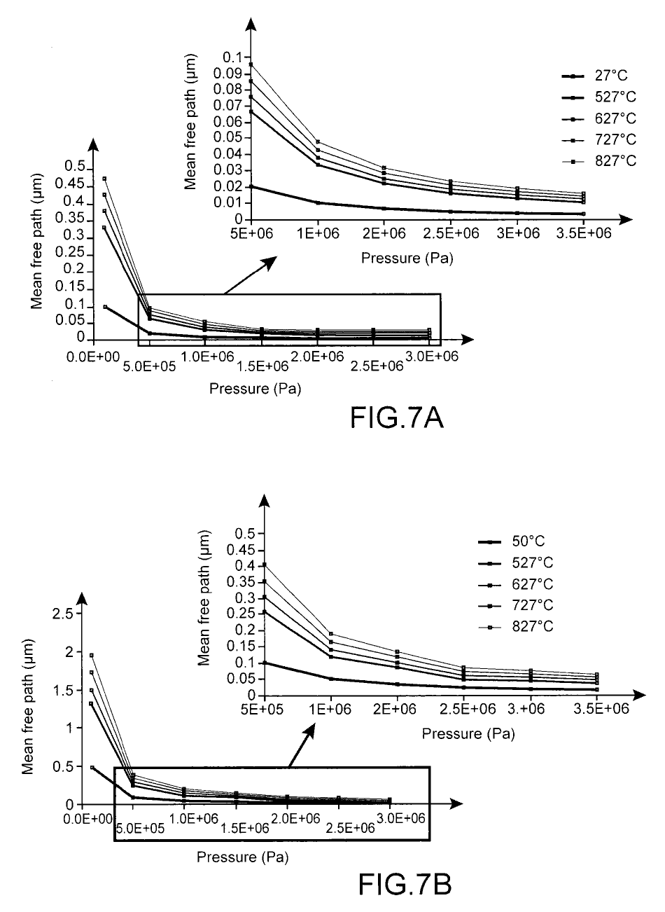

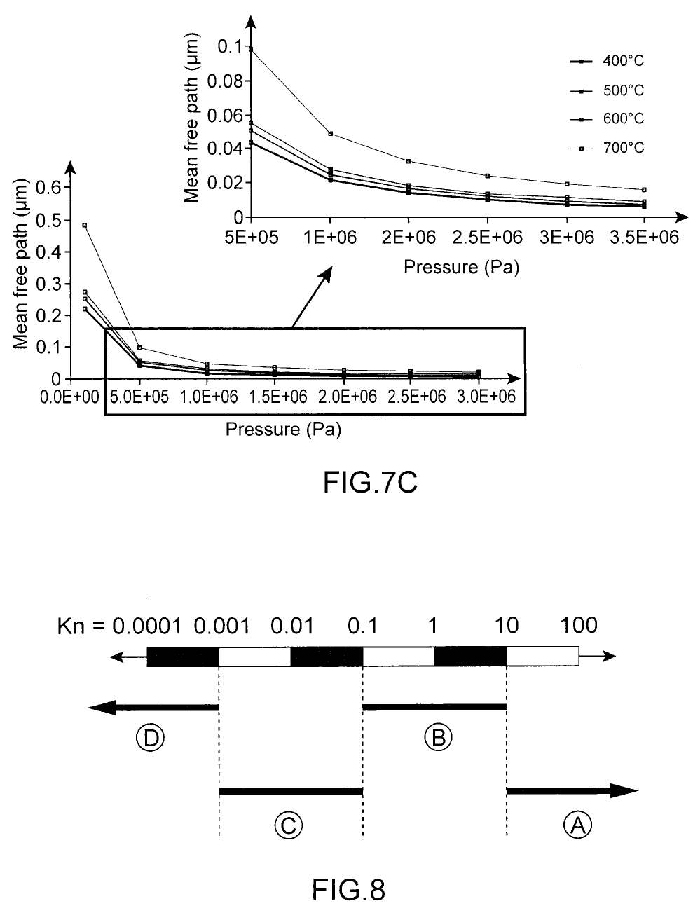

In FIGS. 7A, 7B and 7C for the three gases of the preferred application, namely respectively air, hydrogen and steam, the representative curve of the mean free path according to the temperature and pressure to which they are subject have been represented. It can be seen that for the three gases the mean free path increases with temperature, and decreases very significantly with pressure.

In the case of steam the mean free path is almost of the same level as air (around 0.5 μm at atmospheric pressure and at 700° C.). In the case of hydrogen the mean free path is greater. This corroborates the relative values for effective collision cross-section, since that of hydrogen is lower than those of oxygen and of steam, which are roughly equal.

To estimate the flow characteristics of a gas (flow in a porous medium according to a law of the Darcy type, or a molecular flow), the Knudsen Kn number is used, defined by the ratio between the mean free path and the characteristic length of the channel where the flow occurs, for example the diameter of a capillary. The diagram of FIG. 8 illustrates clearly the different types of flow according to the value of the Knudsen number. It is estimated that there begins to be a significant contribution of the molecular flow from Kn=0.1 and higher; above Kn=10 there the molecular flow characteristics are all of a single type. Thus, in the diagram of FIG. 8:

A designates a free molecular flow;

B designates a flow with transient characteristics;

C designates a slip flow;

D designates a flow with continuous transient characteristics.

In other words, according to this first method of determination, at given pressure and temperature, if the characteristic length of the microchannels according to the invention becomes less than a value equal to 10 times the mean free path, the seal according to the invention may be considered as starting to be effective. The seal is most effective from a characteristic microchannel length of less than 0.1 times the mean free path.

The second method consists in measuring the mass flow of a leak according to the additional pressure either side of a seal. If the relationship is quadratic it is then considered that this is more a flow of the Darcy type. If the relationship is linear, it is then considered that this is more a molecular flow.

Furthermore, if the standardised volume flow rates are taken into account they may be expressed with the following equations for measurements of leakage of air and of H₂,

(2):

$${\dot{V}}_{H 2} = \sqrt{\frac{{M}_{Air}}{{M}_{H 2}}} {\dot{V}}_{air}$$

for molar flow characteristics of the Knudsen type;

(3):

$${\dot{V}}_{H 2} = \frac{{σ}_{H 2}^{2} \sqrt{{M}_{air}}}{{σ}_{air}^{2} \sqrt{{M}_{H 2}}} {\dot{V}}_{air}$$

for Darcy characteristics;
equations (2) and (3) in which:

\dot{V}H2 and \dot{V}air designate respectively the air volumes normalised to H2 and air Nm³/s;

σ_{H2} et σₐᵢᵣ designate respectively the effective collision diameter of H2 and of air in nanometres (nm);

MH2 and Mair designate respectively the molar mass of H2 and of air in g/mol.

Comparison of the experimental and theoretical ratios \dot{V}_{H2}/\dot{V}ₐᵢᵣ also enables the type of flow in the microchannels according to the invention to be assessed.

### CITED REFERENCE

[1]: J. Martin, “Etanchéité en mécanique” [Sealing In mechanics], B 5 420, Techniques de l'Ingénieur [Engineering Techniques], online edition 2009.

1-12. (canceled)

13. A device forming a seal to separate two spaces each occupied by a gas, wherein the gases react with one another to form a fluid, the device comprising:
at least one plate and one buffer chamber separating the two spaces, and wherein the buffer chamber may be occupied by a same fluid as a fluid formed by reaction of the two reactive gases with one another, wherein:
a first space of the two spaces is separated from the chamber by a first supporting portion and a plate portion facing the first supporting portion;
a second space of the two spaces is separated from the chamber by a second supporting portion and a plate portion facing the second supporting portion;
each of the first and second supporting portions forms with the plate portion facing it a supporting area defining a microchannel, the microchannels being porous volumes delimited by surface roughnesses of the first and second supporting portions and of the plate portions; and
a flow of the reactive gases in the microchannels is principally of molecular type.

14. A device forming a seal according to claim 13, wherein walls of the chamber and the first and second supporting portions are formed in a single separation element sandwiched between the first and second spaces.

15. A device forming a seal according to claim 14, wherein the separation element includes a pressed plate.

16. A device forming a seal according to claim 15, wherein the plate is made of nickel alloy, or Inconel 600, or Inconel 718, or Haynes 230.

17. A device forming a seal according to claim 15, wherein the plate is made from a stainless steel, or AISI 310S, or AISI 316L or AISI 430.

18. An electrochemical reactor comprising at least one device forming a seal according to claim 13, wherein the first and second spaces separated by the seal are spaces where the reactive gases flow inside the reactor.

19. An electrochemical reactor according to claim 18, comprising a stack of elementary electrolysis cells, each formed of a cathode, an anode, and an electrolyte sandwiched between the cathode and the anode,
wherein at least one interconnecting plate is fitted between two adjacent elementary cells, in electrical contact with an electrode of one of the two elementary cells and an electrode of the other of the two elementary cells,
wherein the interconnecting plate delimits at least one cathodic compartment and at least one anodic compartment for gas to flow respectively in the cathode and in the anode, and
wherein the cathodic compartment or the anodic compartment constitutes one of the first and second spaces separated by the device forming a seal.

20. A reactor according to claim 18, configured to operate at temperatures of over 450° C., or between 600° C. and 1000° C.

21. A reactor according to claim 18, constituting a fuel cell of SOFC type, configured to operate at temperatures of between 600° C. and 1000° C.

22. A fuel cell of the SOFC type according to claim 21, configured to operate with gases at pressures close to atmospheric pressure.

23. A fuel cell of the SOFC type according to claim 22, wherein the buffer chamber has dimensions of:
a height between 100 and 500 μm, wherein the height is defined as distance between a base of the chamber and the support surface; and
a width at least equal to 500 μm, wherein the width is defined as minimum distance between the two supporting portions of the separation element.

24. A fuel cell of SOFC type according to claim 23, wherein a bearing force between the supporting portions and the plate portions is between 0.1 N/mm and 10 N/mm.
